(19) United States
(12) Patent Application Publication
(10) Pub. No.: US 2009/0260272 A1
(43) Pub. Date: Oct. 22, 2009

(54) Bird Repellant Distribution System

(75) Inventor: Bruce Donoho, Mission Viejo, CA (US)

Correspondence Address: FISH & ASSOCIATES, PC;ROBERT D. FISH, 2603 Main Street, Suite 1000, Irvine, CA, 92614-6232, US

(73) Assignee: BIRD-B-GONE, INC., Mission Viejo, CA (US)

(21) Appl. No.: 12/104,170

(22) Filed: Apr. 16, 2008

(51) Int. Cl. A01M 7/00; A01N 37/44; A01P 17/00

(52) U.S. Cl. 43/1; 514/535

(57) ABSTRACT

A centralized control unit directs compressed air towards fog generators in different repellant locations to distribute atomized bird repellant. The control unit can contain a timer module that controls the time, duration, and recurrence of the mist pulses to optimize bird repellant use. Multiple bird repellant storage tanks can be placed in each fog generator, or a single, common bird repellant storage tank can be used to deliver bird repellant to each fog generator.

### FIELD OF THE INVENTION

The field of the invention is bird repellant atomizers.

### BACKGROUND

It is known in the art to use chemical bird repellants to ward off animals. Methyl anthranilate, for example, is a naturally occurring GRAS (generally recognized as safe) compound that irritates pain receptors in birds and drives them away. Atomizing a methyl anthranilate composition so that it can be inhaled in mist or fog form increases the efficacy.

US 2004/0035879 to Vergote teaches a device that atomizes liquid repellants using an air compressor. Vergote, however, is ineffective at distributing a repellant across distances greater than a few meters. If the output of Vergote is increased, the droplets will saturate the air outside the exhaust port, forming larger droplets that will tend to fall to the ground or bind to the surroundings. In order to cover a greater distance, multiple vaporizers must be used. Vergote and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

US 2007/0141098 and 7334745, both to Crawford, teach a dry bird repellant apparatus that creates a haze using a venturi nozzle, and then blows air into the haze to separate the droplets into a “dry bird repellant.” Since the droplet sizes are smaller, the dry bird repellant can travel greater distances. However, as the output tube is lengthened, the dry bird repellant particles will tend to adhere to the sides of the tube during travel, and the concentration of bird repellant particles will substantially decrease at greater distances.

Thus, there is still a need for a bird repellant vaporizer that can cover great distances.

### SUMMARY AND PREFERRED EMBODIMENTS

The present invention provides apparatus, systems and methods in which a single source of compressed air atomizes repellant in different repellant locations. Each repellant location has a nozzle, preferably a venturi nozzle, which is connected to both the source of compressed air, and a storage tank of liquid repellant. When the compressed air is blown through the nozzle, some of the repellant is drawn up into the nozzle to atomize into the repellant location.

Preferably, the source of compressed air is an air compressor that maintains a minimum psi pressure, preferably at least 50, 100, 150, or 200 psi. The air pressure can be maintained, for example, by a regulator that activates the air compressor whenever the psi pressure drops below a threshold, and deactivates the air compressor when the psi pressure exceeds that threshold. A gage can be attached to an output line from the air compressor to prevent control a pressure output from the tank. Multiple gages with multiple output lines could be used, for example a high-pressure gage and a low-pressure gage can be used to create a high-pressure source and a low-pressure source, respectively. A typical air compressor includes an electric or other motor, and at least one compressed air tank.

An airtight seal, preferably a solenoid valve, can be placed along the air passage to control how long and how often compressed air blows through a nozzle. The valve can be normally closed, and only opened when replant needs to be atomized so as not to waste repellant or supersaturate the air by constant atomization. When the system is operating to repel birds, the valve is preferably opened in short pulses over a period of time to create a series of atomizing pulses.

A timer can be connected to a solenoid valve that can designate how long a pulse lasts, the time in between pulses, and when the pulses should occur. For example, a flip-flop timer could designate a given valve to open every 10 minutes for at most 2 seconds, or could designate a series of valves to open for 5 seconds. A scheduling timer attached to the flip-flop timer could designate a phase of operation to be during daylight.

A preferred bird repellant is one that has methyl anthranilate, since it is non-toxic yet has been proven to drive birds away. Multiple repellant tanks can be directly attached to the nozzle at each repellant location, away from the air compressor, to prevent the repellant from corroding or damaging the air compressor and the timer. Alternatively, a single repellant tank can be used to supply repellant to multiple nozzles. In a preferred embodiment, a low pressure gage pumps air, preferably no more than 15 or 20 psi, into the repellant tank to push liquid repellant through hoses towards the nozzles. A second solenoid valve can be attached to the hose near each nozzle, and attached to the timer. This way, when the timer opens both valves, the released compressed air vaporize the released repellant in a single pulse.

Threshold indicators can be used on the repellant tanks to indicate when the volume of repellant in the tank has dropped below a specified threshold. The indicator can set of a warning or an alarm for a user to replace or refill the tank, or can trigger an automatic refill via an automated system.

A repellant location is the area that is affected by the atomized repellant to repel the desired animal, for example birds. Preferably, the repellant locations do not substantially overlap, so as to cover a maximal area. Each repellant location area of effect can be increased by blowing air through the venturi nozzle at a higher velocity, which not only spreads the fog farther, but also decreases the droplet size. A “fog” is defined herein to mean distributions in which the mean droplet diameter is no more than 20 μm, although preferred fogs have droplet diameter of no more than 10, 8 or even 6 μm.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a control unit coupled with two fog generators.

FIG. 2 is a schematic of an alternative control unit with two alternative fog generators.

FIG. 3 is a map showing the locations of a control unit and a plurality of fog generators.

### DETAILED DESCRIPTION

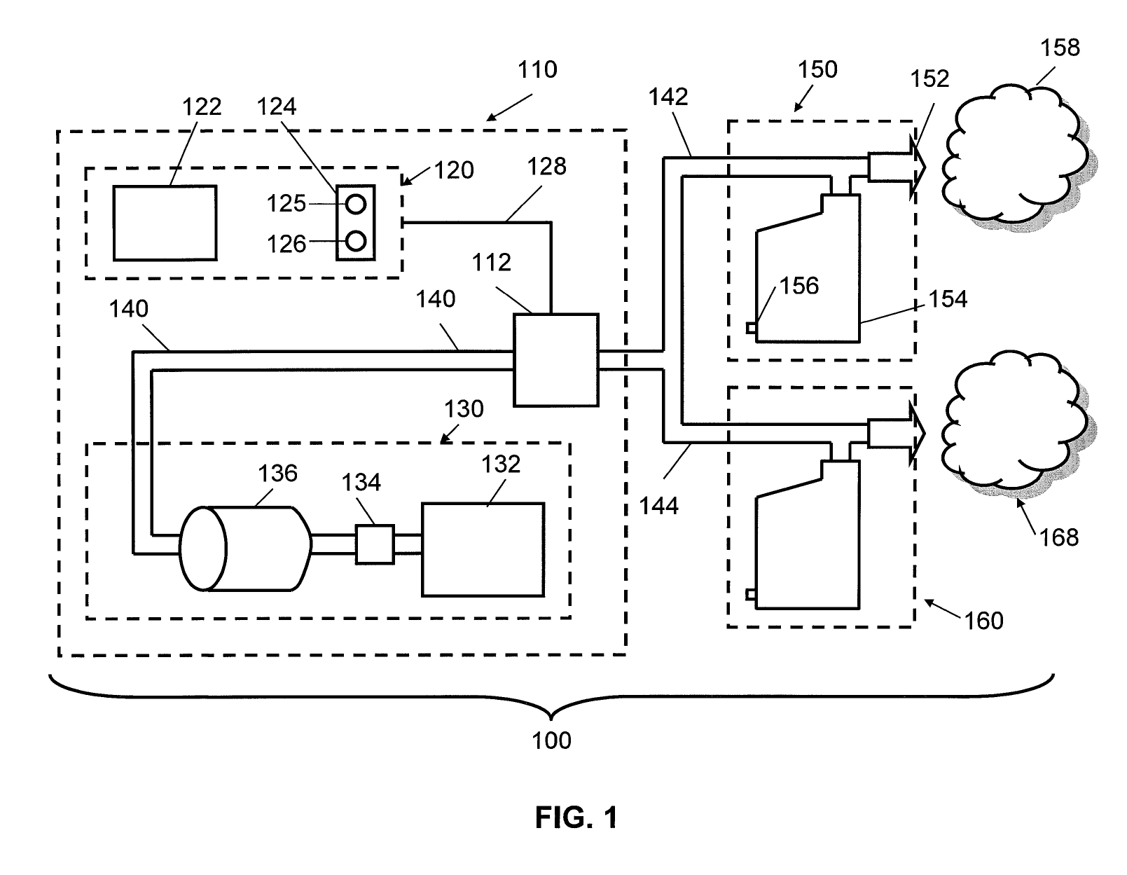

Referring to the drawings to illustrated preferred embodiments, but not for the purpose of limiting the invention, FIG. 1 illustrates a bird repellant sprinkler system 100 generally includes a control unit 110 and multiple fog generators 150 and 160.

Control unit 110 has an air compressor 130, a pressure regulator 134, a solenoid valve 112, and a timer 120.

Air compressor 130 typically has a motor 132, a pressure regulator 134, and a tank 136. Pressure regulator 136 is maintains a minimum pressure in tank 136 preferably using a pressure gage connected to an electronic circuit, although other suitable means can be used. One method of maintaining an air pressure is to turn the motor on when the air pressure in the tank drops below a certain threshold, and to turn the motor off when the air pressure in the tank rises above a certain threshold. The threshold to turn the air compressor off can be different than the threshold to turn the air compressor on. For example, if a user prefers the pressure threshold to be between 100-150 psi, the motor of the air compressor can turn off when the pressure rises above 150 psi and turn on when the pressure drops below 150 psi.

It is contemplated that the air pressure in the air tank can be adjusted as needed. Bird repellant can generally be adequately vaporized using a minimum air pressure of 40 psi. However, since the size of vaporized bird repellant particles can be reduced and the fog dispersion can be increased by increasing the air pressure that is pumped to the nozzles, a higher air pressure is preferred, for example at least 100 psi or 150 psi.

Compressed air is fed to fog generators 150 and 160 through solenoid valve 112. Solenoid valve 112 can be any suitable size and can be made of any suitable material to create an airtight seal between air line 140 and air lines 142 and 144 when closed. When opened, the pressurized air from air line 140 escapes into air lines 142 and 144 to create an atomizing pulse at fog generators 150 and 160. Those skilled in the art will appreciate that the solenoid valve can open a mere gap or can open fully to allow the compressed air to escape.

Timer 120 has a scheduling timer 122 and a flip-flop timer 124 that controls when solenoid valve 112 opens and closes with control wire 128. Scheduling timer 122 designates when the system is active according to a set schedule, for example a certain time of day for a 24-hour timer, or the times of days on various weekdays for a weekly timer. If a user wanted to set the system to repel birds during business hours, the user could set the system to turn on during the hours of 8 AM-6 PM on weekdays. Or, if the user wants to prevent the birds from “learning” the system schedule, the user can set the scheduling timer to randomize the activation time of the system. In general, it is considered advantageous to release pulses of fog during daylight and twilight hours, and prevent such release during night time hours. Although, in some situations, such as when protecting the rooftop of an evening ballgame, repelling birds during night time hours is preferred.

Flip-flop timer 124 controls how long the solenoid valve is opened and closed. In the current embodiment, knob 125 controls how long the solenoid valve remains open in seconds, and knob 126 controls how long the solenoid valve remains closed in minutes. For example, if knob 125 was set to 2 and knob 126 was set to 10, the solenoid valve would remain open for 2 seconds, and then would remain closed for 10 minutes before opening again for 2 seconds. While the current embodiment of flip-flop timer 124 was chosen for simplicity, it is appreciated that alternative flip-flop timer configurations are also suitable.

Fog generator 150 generally comprises a venturi nozzle 152 and a bird repellant tank 154. Pressurized air from air line 140 withdraws a small amount of bird repellant from the bird repellant tank 154 and shoots it through venturi nozzle 152 to create bird repellant fog 158. A tube (not shown) can be inserted into repellant tank 154 to help draw liquid from the bottom of the tank, and a filter (not shown) can be used to prevent larger droplets from escaping.

Alarm 156 is attached to bird repellant tank 154 to detect the amount of bird repellant left in the tank, and to activate when the level in the tank drops below a certain threshold. Alarm 156 is preferably configured to notify maintenance staff that the volume of bird repellant is low and the tank needs to be replaced or refilled. Alarm 156 can notify maintenance staff using any suitable method, for example a sonic beep, a blinking light, or an electronic signal sent to a central office. Preferably, alarm 156 could even automatically draw bird repellant from a central storage unit and automatically refill the tank.

Fog generator 160 is identical to fog generator 150, except fog generator 160 receives pulses of air through air line 144, and distributes bird repellant fog 168 to a separate repellant location. It is appreciated that while fog generator 160 is identical to fog generator 150 to reduce complexity of the specification, the fog generators can be different from one another.

It is also appreciated that while solenoid valve is preferably located in control unit 110 as shown, multiple solenoid valves can be attached to an input of the venturi nozzles 152, with multiple wires running from timer 120 to control each solenoid valve. In such an embodiment, the solenoid valves could be opened simultaneously, one at a time, or any combination thereof.

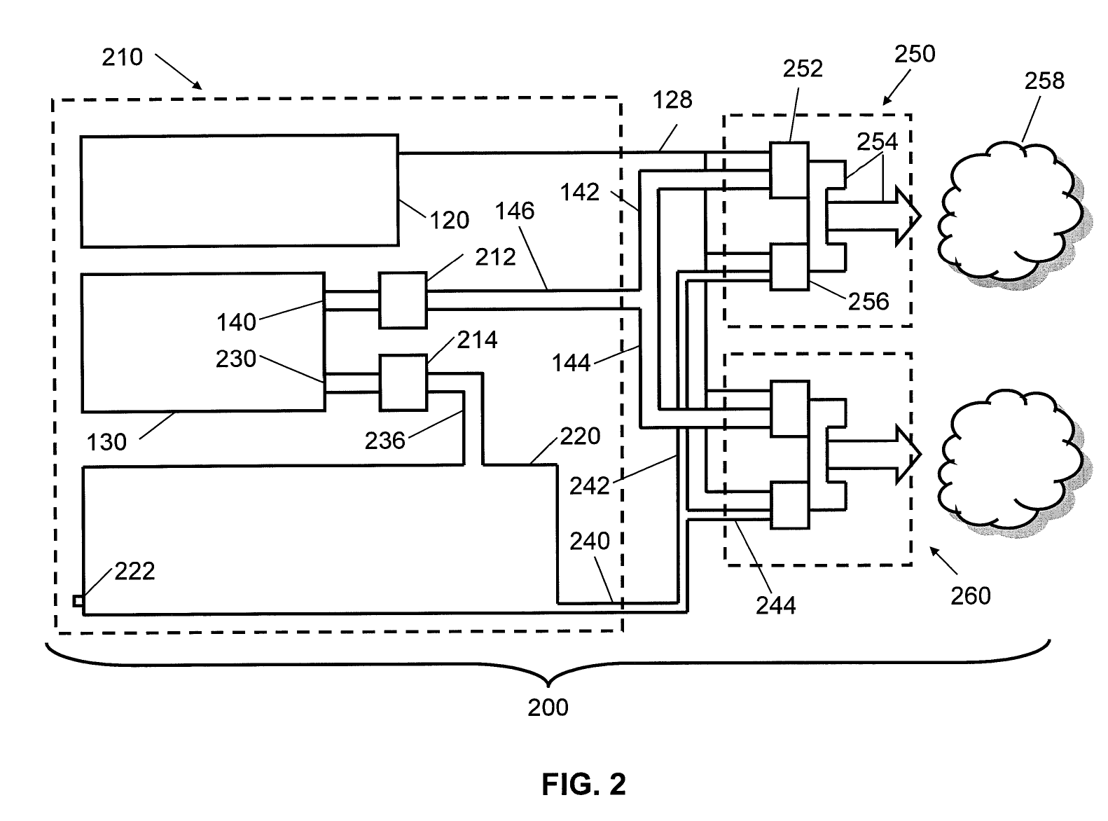

FIG. 2 shows an alternative embodiment of a bird repellant sprinkler 200 generally including a control unit 210 coupled with fog generators 250, 260.

In this embodiment, a single bird repellant tank 220 supplies bird repellant to multiple fog generators 250, 260. Two air lines 140, 230 are used to supply high pressure air to fog generators 250, 260 and low pressure air to bird repellant tank 220, respectively. A high pressure gage 212 is coupled to air line 140 to control a high pressure output to air line 146 while a low pressure gage 214 is coupled to air line 230 to control a high pressure output to air line 236. Pressure gages 212 and 214 can control the pressure output by constricting and expanding a valve. Preferably, high pressure gage 212 restricts the output pressure into air line 146 to a maximum of 150 psi, and low pressure gage 214 restricts the output pressure into air line 236 to a maximum of 15 psi. A person of ordinary skill in the art can appreciate that a variety of pressures can be used without departing from the scope of the invention.

The low pressure air from air line 236 applies pressure to the bird repellant (not shown) in bird repellant tank 220 to push the liquid into fog lines 240, 242, and 244 and to fog generators 250, 260. This is an advantageous method of using a single air compressor to deliver both compressed air and bird repellant to fog generators located in remote locations and/or high altitudes.

Bird repellant tank 220 has an alarm 222 similar to alarm 156, which can notify maintenance staff that the volume of bird repellant is low. Since the current embodiment only has one bird repellant tank, the maintenance staff does not need to check each fog generator to refill the tank. This is ideal when the fog generators are placed in locations that are difficult to maintain, for example the side of a building or the top of a lamp post.

While control unit 210 is shown as one unit, and is preferably one unit for maintenance purposes, control unit 210 can be divided into multiple units without departing from the scope of the invention. Bird repellant tank 220 can be maintained separately so as not to damage timer 120 or air compressor 130. Additionally, timer 120 can be placed on an outside of control unit 210 for ease of accessibility.

Fog generator 250 receives pressurized air from air lines 142 and pressurized bird repellant in fog line 242 which are both fed into venturi nozzle 254. Valve 252 and valve 256 are controlled by timer 120, which opens the valves according to a set schedule. When valve 252 and valve 256 are opened, the pressurized air from air line 142 withdraws a small amount of bird repellant from line 146 and vaporizes it through venturi nozzle 254 to create repellant fog 258. Preferably, all valves are opened and closed simultaneously, but timer 120 can control each valve individually and independently from one another.

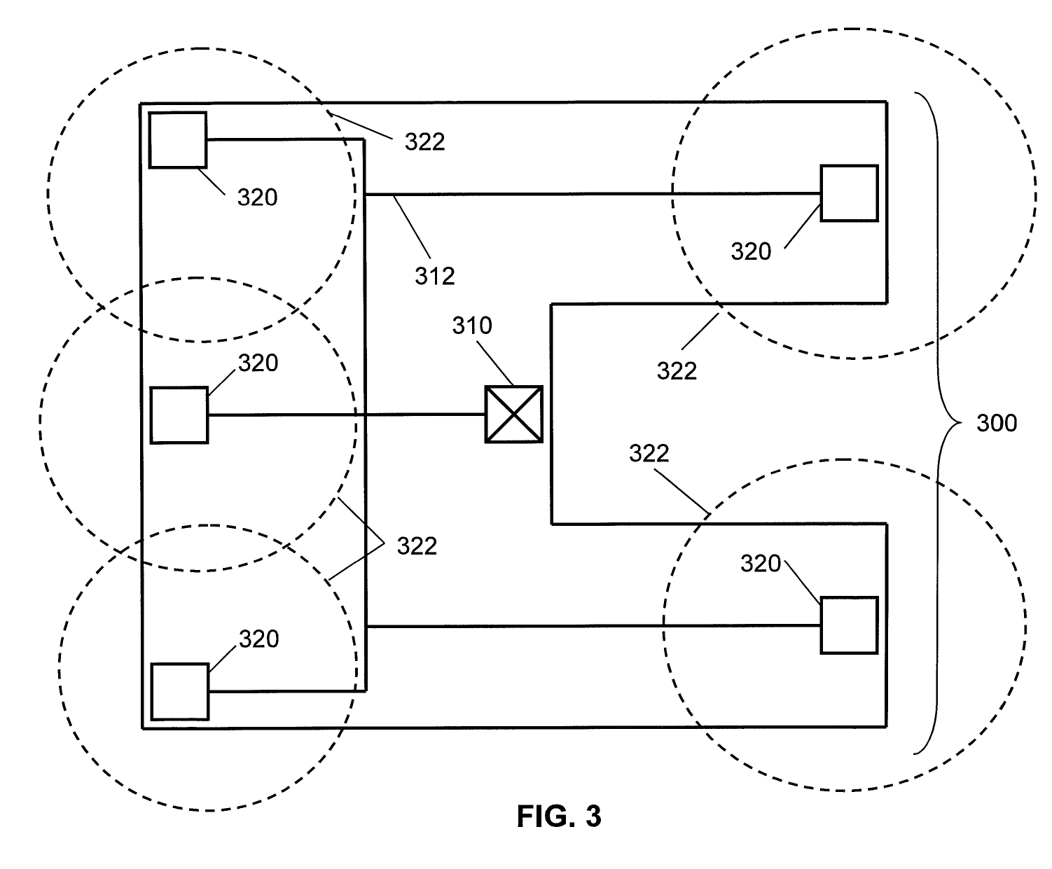

In FIG. 3, a bird repellant sprinkler system on building 300 repels birds from repellant locations 322 using control unit 310 and fog generators 320.

Control unit 310 remotely activates fog generators 320 from a central location. Each fog generator 320 is capable of generating a fog of bird repellant, generally a composition comprising methyl anthranilate, which covers a repellant location 322. The shape, size, and volume of repellant locations are dependent on environmental considerations, for example the speed and direction of wind or the orientation of the vaporizing nozzle (not shown). While repellant locations may overlap, minimal overlap is preferred so as to maximize the effective area of the bird repellant. The fog generators 320 can be connected via a wire 310 or remotely. The repellant locations are preferably at least five meters away from each other, and are more preferably at least fifteen or twenty meters away from one another to prevent any overlap whatsoever.

Separating the fog generators from each other and the control unit by a significant distance reduces the amount of methyl anthranilate residue, which can have a detrimental effect on equipment since methyl anthranilate in its liquid form is relatively caustic. For that same reason, it is preferred that the fog is produced in short vapor pulses to prevent the air from being supersaturated with vaporized repellant, which could coagulate into large droplets that form a residue on the surfaces that contact the droplets. Additionally size of the droplets can be reduced and the fog dispersion can be increased by increasing the air pressure that is pumped to the nozzles.

Using a single control unit 310 is also advantageous as it significantly reduces the cost of the equipment, since the most expensive components are generally the air compressor and timing mechanisms. Instead of purchasing five air compressors and five timing mechanisms to cover five areas, a single air compressor can be used to deliver fog repellant in five different locations, and a single timer can be used to administer five fog generators.

Thus, specific embodiments and applications of sprinkling bird repellant fog in multiple areas from a central location have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method for distributing a repellant fog, comprising:
fluidly coupling a first venturi nozzle in a first dispenser to a first container holding an amount of an aqueous repellant;
fluidly coupling a second venturi nozzle in a second dispenser to at least one of the first and a second container holding another amount of the aqueous repellant;
fluidly coupling a source of compressed air to the dispensers in parallel fashion to produce (a) first and second vacuums at the first and second dispensers, and (b) first and second fogs at the first and second nozzles, respectively;
positioning the first venturi nozzle to atomize repellant into a first repellant location; and
positioning the second venturi nozzle to atomize repellant into a second repellant location.

2. The method of claim 1, wherein the aqueous repellant is a bird repellant.

3. The method of claim 2, wherein the aqueous repellant is methyl anthranilate.

4. The method of claim 1, further comprising detecting a volume of repellant within the first container.

5. The method of claim 4, further comprising providing a warning to replace the first container when the volume of the repellant drops below a threshold.

6. The method of claim 4, further comprising adding repellant to the first container when the volume of the repellant drops below a threshold.

7. The method of claim 1, wherein the source of compressed air is an air compressor having a motor and a tank.

8. The method of claim 7, further comprising utilizing an electronic circuit to maintain a minimum pressure in the tank.

9. The method of claim 8, wherein the minimum pressure is at least 100 psi.

10. The method of claim 8, wherein the minimum pressure is at least 200 psi.

11. The method of claim 7, further comprising utilizing a first gage to control a high pressure output of the tank.

12. The method of claim 11, wherein the high pressure output is at most 150 psi.

13. The method of claim 11, further comprising using a second gage to control a low pressure output of the air compressor.

14. The method of claim 13, wherein the low pressure output is at most 15 psi.

15. The method of claim 13, further comprising fluidly coupling the low pressure output to the first container to push the repellant to each of the first and second venturi nozzles and using the high pressure output to create the vacuums.

16. The method of claim 1, further comprising releasing air from the source of compressed air in a series of pulses during a phase of operation.

17. The method of claim 16, wherein each pulse lasts at most 5 seconds.

18. The method of claim 16, wherein each pulse lasts at most 2 seconds.

19. The method of claim 16, wherein a time between two pulses is at most 10 minutes.

20. The method of claim 16, wherein the phase of operation occurs according to a timed schedule.

21. The method of claim 1, wherein the first repellant location is at least 5 meters away from the source of compressed air.

22. The method of claim 1, wherein the first repellant location is at least 15 meters away from the source of compressed air.

23. The method of claim 1, wherein the first repellant location is at least 15 meters away from the second repellant location.

24. A system that distributes a bird repellant fog, comprising:
an air compressor;
a first pneumatic passage coupled to a first venturi nozzle and the air compressor;
a second pneumatic passage coupled to a second venturi nozzle and the air compressor;
a first liquid passage coupled to the first venturi nozzle and a first bird repellant container; and
a second liquid passage coupled to the second venturi nozzle and at least one of the first bird repellant container and a second bird repellant container.

25. The system of claim 25, further comprising a first gage coupled to the first pneumatic passage.

26. The system of claim 25, further comprising a third pneumatic passage coupled to the air compressor and the first bird repellant container.

27. The system of claim 26, further comprising a second gage coupled to the third pneumatic passage.

28. The system of claim 24, further comprising an airtight valve that seals a pneumatic passage from the air compressor to the first and second pneumatic passages.

29. The system of claim 24, further comprising:
a first airtight valve that seals the first pneumatic passage; and
a second airtight valve that seals the second pneumatic passage.

30. The system of claim 28, wherein the airtight valve is a solenoid valve.

31. The system of claim 27, further comprising a liquid-tight valve that seals the first liquid passage.

32. The system of claim 31, wherein the liquid-tight valve is a solenoid valve.

33. The system of claim 28, further comprising a timer module coupled to the airtight valve.

34. The system of claim 31, further comprising a timer module coupled to the airtight valve and the liquid-tight valve.

35. The system of claim 33, wherein the timer module comprises a flip-flop timer.

36. The system of claim 33, wherein the timer module comprises a scheduling timer.

37. The system of claim 33, wherein the timer module comprises a relay.

38. The system of claim 24, wherein the first pneumatic passage is at least 5 meters long.

39. The system of claim 24, wherein the first pneumatic passage is at least 15 meters long.
